(19) United States
(12) Patent Application Publication
(10) Pub. No.: US 2018/0134244 A1
(43) Pub. Date: May 17, 2018

(54) FRONT AIRBAG FOR VEHICLE

(71) Applicant: HYUNDAI MOTOR COMPANY, Seoul (KR)

(72) Inventor: Jun Yeol Choi, Seoul (KR)

(73) Assignee: HYUNDAI MOTOR COMPANY, Seoul (KR)

(21) Appl. No.: 15/495,501

(22) Filed: Apr. 24, 2017

(30) Foreign Application Priority Data
Nov. 11, 2016 (KR) 10-2016-0150545

(51) Int. Cl. B60R 21/231; B60R 21/2338; B60R 21/239

(52) U.S. Cl. CPC B60R 21/231; B60R 21/2338; B60R 2021/0048; B60R 2021/23382; B60R 2021/23123; B60R 21/239

(57) ABSTRACT

Disclosed is a front airbag for a vehicle comprising an air bag cushion including front and rear panels on which a passenger is received safely; an air bag housing in which the air bag cushion is installed and to which the rear panel is affixed; a first panel tether provided in a vertical direction inside the air bag cushion and connecting the air bag housing and the front panel; and a second panel tether provided in a vertical direction inside the air bag cushion and connecting the air bag housing and the front panel, wherein the length of the second panel tether from the air bag housing to the front panel is longer than the length of the first panel tether from the air bag housing to the front panel.

### CROSS REFERENCE TO RELATED APPLICATION

The present application claims benefit of and priority to Korean Patent Application No. 10-2016-0150545 filed on Nov. 11, 2016, the entire contents of which is incorporated herein for all purposes by this reference.

### BACKGROUND

### Technical Field

The present disclosure relates to an air bag which is positioned in front of passengers in a vehicle. More specifically, the present invention relates to an air bag for preventing passengers from colliding with a structure such as a crash pad or a center fascia and further preventing damage to the neck or brain due to rotation of the head when oblique collision of vehicles occurs.

### Description of the Related Art

As interest in passenger safety in addition to vehicle functionality and convenience increases, the importance of safety-related devices that can protect passengers in the event of accident is also increasing. Among safety devices for protecting passengers, an air bag system is the most basic protective system for dispersing impact exerted on passengers in the event of vehicle collision.

A front air bag that is positioned in front of passengers serves to prevent passengers from directly colliding with various structures inside the vehicle and also serves to block impact energy transmitted from the outside in the event of vehicle collision.

However, conventional airbags have problems in that in the event of oblique collision of vehicles, passengers cannot be protected sufficiently by means of those air bags. Situations can occur where passengers collide directly with a center fascia, or where the neck and brain of the passenger are injured because the passengers head slides along and off a surface of the deployed air bag.

The foregoing serves as to promote better understanding of the background of the present invention, and is not an admission as to the scope of the art well known to those of ordinary skill in the art.

### SUMMARY OF THE DISCLOSURE

The present disclosures addresses the abovementioned problems. It is an object of the present disclosure to provide a front air bag capable of preventing, in the event of oblique collision of vehicles, a situation where the head of a passenger collides directly with a center fascia and the like or a situation where the head or neck of the passenger is injured due to the head sliding along and off a surface of the air bag.

In an example embodiment, a front air bag for a vehicle according to the present disclosure comprises an air bag cushion including front and rear panels on which a passenger is received safely; an air bag housing in which the air bag cushion is installed and to which the rear panel is affixed; a first panel tether provided in a vertical direction inside the air bag cushion and connecting the air bag housing and the front panel; and a second panel tether provided in a vertical direction inside the air bag cushion and connecting the air bag housing and the front panel, wherein the length of the second panel tether from the air bag housing to the front panel is configured to be longer than the length of the first panel tether from the air bag housing to the front panel.

The first panel tether may be connected to a central portion of the front panel.

A plurality of first and second panel tethers may be provided wherein the second panel tethers may be disposed farther towards the outer edges of the front panel than the first panel tethers.

A plurality of first and second panel tethers may be provided wherein the first panel tethers and the second panel tethers may be disposed alternately with respect to the width direction of the front panel and the second panel tether is disposed at the outermost side.

The first panel tether and the second panel tether may be configured in a fan shape extending in an vertical direction about a portion connected to the air bag housing wherein an arc portion of the fan shape is connected to the front panel.

The length of the arc of the first panel tether may be configured to be longer than length of the arc of the second panel tether.

The arc portion of the first panel tether may be configured such that a central portion thereof is recessed toward the air bag housing.

The front air bag may further comprise a through-hole provided in the first and second panel tethers to form a hollow portion across the width of the air bag cushion; and a horizontal tether having left and right ends that pass through the through-holes and are fixed to the air bag cushion.

The front air bag may further comprise a vent hole provided on a side surface of the airbag cushion; a cover for opening and closing the vent hole; and a vent cord connected to the cover at one end and to the central portion of the front panel at the other end and provided in such a manner that the cover closes the vent hole at the time of being deployed.

The front air bag may further comprise a screen panel interconnecting both ends of the front panel.

A safe receipt portion recessed into a central side of the first panel tether may be formed at a lower side of the air bag housing side of the first panel tether and the safe receipt portion may be coupled with the rear panel corresponding to a position of the safe receipt portion.

During deployment of the front air bag fora vehicle of the present disclosure as described above in the event of an oblique collision, the head of the passenger contacts the concave portion of the central portion of the front panel of the airbag cushion, thereby preventing the head from sliding along and off the surface of the air bag and hence preventing the head from directly colliding with a structure such as a center fascia.

Further, even when a child is in an unstable or unsafe seating state, it is possible to prevent the air bag cushion from striking the head of the child with the aid of the safe receipt portion formed at the lower side of the air bag cushion.

### BRIEF DESCRIPTION OF THE DRAWINGS

FIG. 1 is a top plan view of a front air bag for a vehicle according to an embodiment of the present disclosure.

FIG. 2 is a top plan view of a front air bag for a vehicle according to another embodiment of the present disclosure.

FIGS. 3 to 5 are sectional side views of a front air bag for a vehicle according to various embodiments of the present disclosure.

### DESCRIPTION OF SPECIFIC EMBODIMENTS

Preferred embodiments of the present disclosure are described in detail with reference to the accompanying drawings. However, the present disclosure is not limited to or restricted by the preferred embodiments.

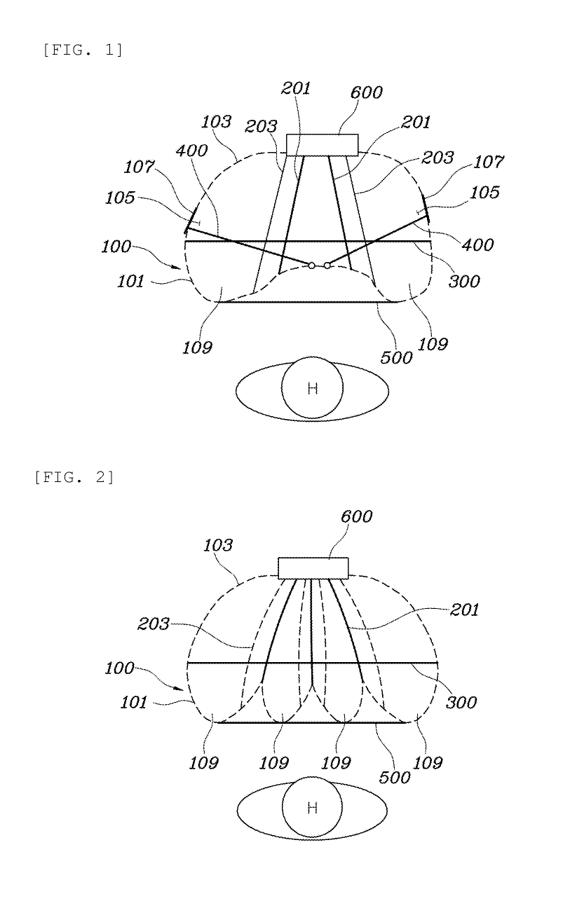

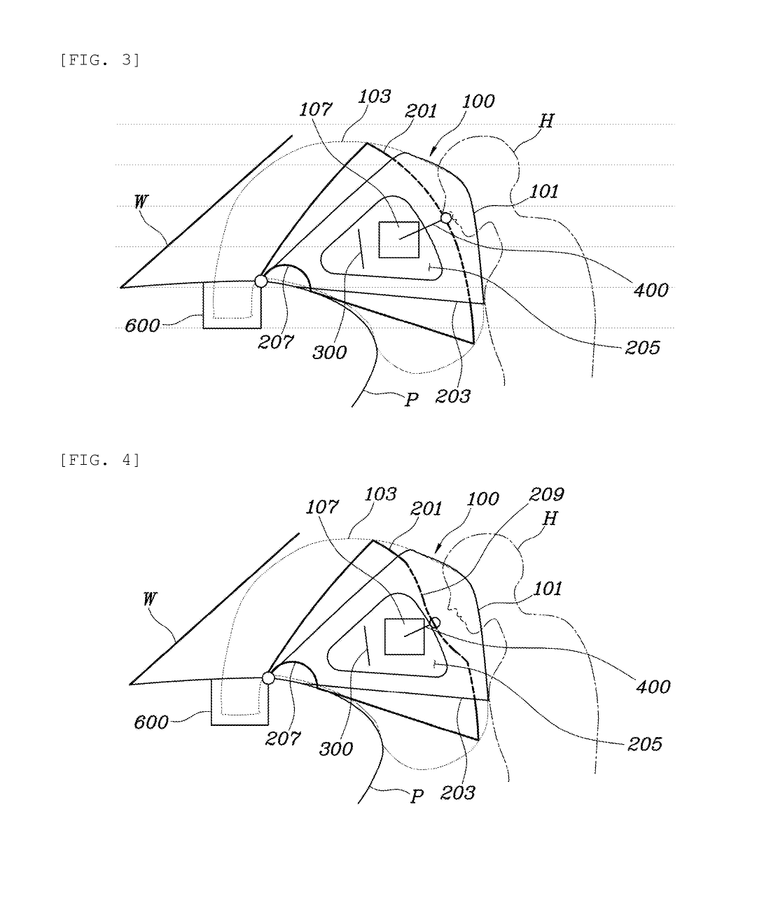

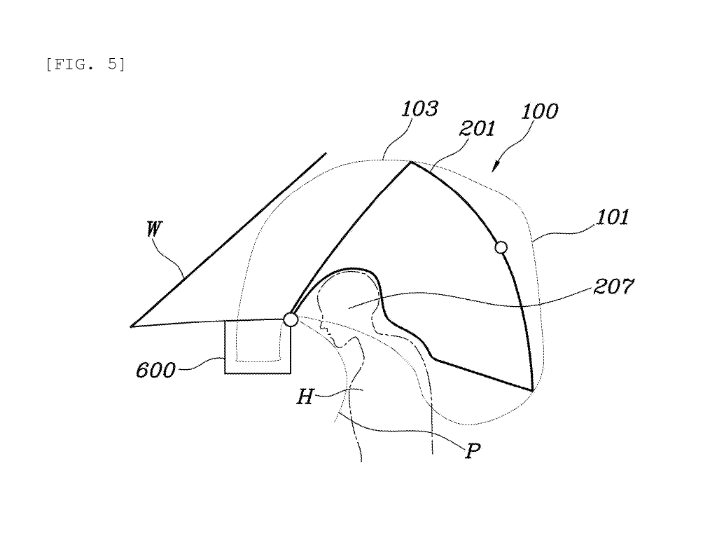

FIGS. 1 and 2 are top plan views showing the internal structure of a front airbag fora vehicle according to various embodiments of the present disclosure; FIGS. 3 and 4 are side views showing the internal structure of a front air bag for a vehicle, which are centered at the first and second panel tether; and FIG. 5 is a view showing a state in which the front air bag for a vehicle according to an embodiment of the present disclosure is deployed when a child is in an abnormal seating state.

A front airbag for a vehicle according to the present disclosure comprises an air bag cushion 100 including front and rear panels 101 and 103 on which a passenger is received safely during a collision; an air bag housing 600 in which air bag cushion 100 is installed and to which rear panel 103 of air bag cushion 100 is affixed; a first panel tether 201 provided in a vertical direction inside air bag cushion 100 and connecting air bag housing 600 and front panel 101 of air bag cushion 100; and a second panel tether 203 provided in a vertical direction inside air bag cushion 100 and connecting air bag housing 600 and front panel 101, wherein the length of second panel tether 203 from air bag housing 600 to front panel 101 is configured to be longer than the length of first panel tether 201 from air bag housing 600 to front panel 101.

First panel tether 201 may be connected to a central portion with respect to a width direction of the front panel 101. A plurality of first and second panel tethers 201, 203 may be provided wherein the second panel tethers 203 may be disposed farther towards the outer edges of front panel 101 than the first panel tethers 201.

Referring to FIG. 1, air bag cushion 100 is configured in such a manner that at the time of deployment, a central portion of front panel 101 is configured to be concave and an outer side of the front panel is formed to protrude as indicated with reference numeral 109. This occurs because first panel tether 201 connected to the central portion of front panel 101 is configured to be shorter than second panel tether 203 connected to the outer side.

In this case, when the vehicle experiences an oblique collision, the head of a passenger is received in the center of front panel 101 and protruding portion 109 at the outer side of front panel 101 serves as a wall that prevents the passenger's head from sliding along and off air bag cushion 100. Thus, it is possible to prevent the passenger's head from directly colliding with a vehicle structure such as a center fascia or a crash pad and prevent injury to the neck due to rotation of the passenger's head.

Referring to FIG. 3, first panel tether 201 and second panel tether 203 may be configured in a fan shape spreading out in a vertical direction about a portion connected to air bag housing 600 wherein an arc portion of the fan shape is connected to front panel 101. The length of the arc of first panel tether 201 may be configured to be longer than that of the arc of second panel tether 203.

The length of the arc of first panel tether 201 is configured to be longer than that of second panel tether 203 so that when air bag cushion 100 is deployed, the height of the central portion of the front panel 101 is larger than the height of protruding portion 109 of front panel 101. This provides sufficient area to protect the head and upper body of the passenger in the event of a frontal collision of the vehicle.

The height of outer protruding portion 109 of front panel 101, which is formed by second panel tether 203, need not be as large as the height of the central portion of front panel 101 because the upper body of the passenger is loaded in a diagonal direction toward the center fascia. Therefore, the length of the arc of second panel tether 203 is configured to be shorter than the length of the arc of first panel tether 201 so that the overall volume of air bag cushion 100 can be reduced.

A plurality of first and second panel tethers 201, 203 may be provided wherein first panel tethers 201 and second panel tethers 203 may be disposed alternately across the width of front panel 101 and wherein first panel tether 201 is disposed at the outermost side of front panel 101.

When first panel tether 201 and second panel tether 203 are disposed alternately and then combined with frontpanel 101, front panel 101 is configured in an embossed shape as shown in FIG. 2. In this configuration, the head of the passenger can be buried in the groove formed on the front panel 101 even if the upper body of the passenger is loaded in the diagonal direction toward the center fascia, thereby preventing the head of the passenger from directly colliding with the structure such as the center fascia, etc.

In a further embodiment, the arc portion of first panel tether 201 may be configured such that a central portion thereof is recessed toward the air bag housing. The central portion 209 of the arc portion of the first panel tether 201 is a point corresponding to the position where the head of the passenger is received. In this embodiment, the central portion of the arc is formed to be recessed as shown in FIG. 4. This is to reduce the amount of deployment of airbag cushion 100 towards the passenger, thereby preventing the situation where the passenger's face strikes airbag cushion 100 with sufficient force to break the passenger's neck.

The front air bag may further comprise a through-holes 205 provided in first and second panel tethers 201 and 203 respectively to form a hollow portion across the width of air bag cushion 100, and a horizontal tether 300 having left and right ends that pass through through-holes 205 and are fixed respectively to the outer edges of air bag cushion 100.

It is possible to optimize the expansion volume of air bag cushion 100 by adjusting the extent of deployment in the width direction of air bag cushion 100 with the aid of horizontal tether 300. Further, even if loading intensity is higher than expected or deployment of the air bag is slower than expected during loading of the passenger, the horizontal tether serves as a preventive screen for preventing direct collision with the crash pad P.

In a further embodiment, as shown in FIG. 1, the front air bag may further comprise a vent hole 105 provided on a side surface of air bag cushion 100; a cover 107 for opening and closing vent hole 105; and a vent cord 400 connected to cover 107 at one end and to the central portion of front panel 101 at the other end and provided in such a manner that cover 107 closes vent hole 105 at the time the air bag is deployed.

When the passenger is loaded on the central portion of front panel 101, vent cord 400 is loosened and thus, vent hole 105 is opened as cover 107 is opened. In this configuration, the internal pressure of air bag cushion 100 can be adjusted after the passenger is loaded on air bag cushion 100, thereby reducing impact energy transferred to the passenger.

In a further embodiment, as shown in FIG. 2, the front air bag may further comprise a screen panel 500 interconnecting both ends of front panel 101 protruding toward the passenger.

The screen panel 500 prevents protruding portion 109 on the outer side of front panel 101 from being excessively expanded in the width direction of airbag cushion 100 so that when the head of the passenger is loaded in the oblique direction, supporting force can be provided by protruding portion 109 on the opposite side of where the head is not loaded firstly.

When the air bag is deployed under an abnormal seating situation in which a child or the like directly contacts crash pad P, a dangerous situation occurs in which the head of the child is directly struck by means of pressure of deployment of air bag cushion 100.

Therefore, in the present disclosure, a safe receipt portion 207 recessed toward the center of first panel tether 201 is provided at the lower side of air bag housing 600 side of first panel tether 201 and safe receipt portion 207 and rear panel 103 are coupled to each other so that a concave space is formed below air bag cushion 100, as shown in FIGS. 3 to 5.

Because the head of the child in an abnormal seating state can be positioned in such a space, it is possible to prevent the air bag cushion 100 from directly striking the head of the child even if air bag cushion 100 is deployed towards the top of the child's head.

Although the present invention has been described and illustrated with respect to specific embodiments, it will be apparent by those who have ordinary skill in the art that various modifications and changes to the present invention may be made without departing from the spirit and scope of the present invention as defined in the appended patent claims.

What is claimed is:

1. A front air bag for a vehicle comprising:
an air bag cushion including front and rear panels;
an air bag housing in which the air bag cushion is installed and to which the rear panel is affixed ;
a first panel tether disposed inside the air bag cushion connecting the air bag housing and the front panel; and
a second panel tether disposed inside the air bag cushion connecting the air bag housing and the front panel,
wherein the length of the second panel tether from the air bag housing to the front panel is longer than the length of the first panel tether from the air bag housing to the front panel.

2. The front air bag of claim 1, wherein the first panel tether is connected to a central portion of the front panel.

3. The front air bag of claim 2, comprising a plurality of first and second panel tethers, wherein the second panel tethers are disposed farther towards the outer edges of the front panel than the first panel tethers.

4. The front air bag of claim 1, comprising a plurality of first and second panel tethers, wherein the first panel tethers and the second panel tethers are disposed alternately across the width of the front panel and the second panel tether is disposed at the outermost side.

5. The front air bag of claim 1, wherein the first panel tether and the second panel tether are each configured in a fan shape extending in a vertical direction about a portion connected to the air bag housing and wherein an arc portion of the fan shape is connected to the front panel.

6. The front air bag of claim 5, wherein the length of the arc of the first panel tether is configured to be longer than the length of the arc of the second panel tether.

7. The front air bag of claim 5, wherein the arc portion of the first panel tether includes a central portion recessed toward the air bag housing.

8. The front air bag of claim 1, further comprising
a through-hole disposed in the first and second panel tethers; and
a horizontal tether having left and right ends that pass through the through-holes in the first and second panel tethers and are fixed to the air bag cushion.

9. The front air bag of claim 1, further comprising
a vent hole provided on a side surface of the air bag cushion;
a cover for opening and closing the vent hole; and
a vent cord connected to the cover at one end and to the central portion of the front panel at the other end,
wherein the cover closes the vent hole when the airbag is deployed.

10. The front air bag of claim 3, further comprising a screen panel interconnecting both ends of the front panel.

11. The front air bag of claim 5, further comprising a safe receipt portion recessed into a central side of the first panel tether at a lower side of the air bag housing side of the first panel tether and coupled to the rear panel.
